(19) United States
(12) Patent Application Publication
(10) Pub. No.: US 2020/0321736 A1
(43) Pub. Date: Oct. 8, 2020

(54) ELECTRICAL OUTLET BOX ASSEMBLY

(71) Applicants: Dove Waynick, Rockwall, TX (US); Devin Waynick, Rockwall, TX (US); Max Probasco, Plano, TX (US)

(72) Inventors: Dove Waynick, Rockwall, TX (US); Devin Waynick, Rockwall, TX (US); Max Probasco, Plano, TX (US)

(73) Assignee: DJW Push, Inc, Rockwall, TX (US)

(21) Appl. No.: 16/907,281

(22) Filed: Jun. 21, 2020

(51) Int. Cl. H01R 13/70; H02G 3/08; H01R 25/00; H02G 3/14

(52) U.S. Cl. CPC H01R 13/701; H02G 3/081; H02G 3/14; H02G 3/086; H01R 25/006

(57) ABSTRACT

The present invention is directed to an electrical outlet box assembly comprising a mounting plate and a modular outlet box. The modular outlet box houses an electrical device and can be coupled to the mounting plate. The modular outlet box having a first contacts module that connects with a conduit from the main power source. The modular outlet box further comprises a second contacts module having contacts for electrically connecting to the electrical device. A conductor link electrically connects the first contacts module and the second contacts module. A circuit breaker housed in the modular outlet box interrupts the conductor link to regulate the flow of current from the first contacts module to the second contacts module.

### FIELD OF INVENTION

The present invention relates generally to an electrical outlet box and, more particularly, to an electrical outlet box assembly used in electrical wiring. The invention also relates to circuit breakers.

### BACKGROUND

Electrical outlet boxes and electrical devices have been well known in the art. These are critical components of an electrical system of a building. Electrical outlet boxes are box-like structures that provide housing for the electrical devices, such as switches and outlet receptacles when installed on the walls, ceilings, or floors. These can be made of metal or plastic and available in different shapes and sizes including round, square, and octagonal boxes. Metal electrical outlet boxes are generally made of steel, while plastic electrical outlet boxes can be made of PVC or fiberglass.

The electrical outlet box safely encloses the electrical connections of the electrical devices to the conduits. Generally, the electrical outlet boxes are cubed or cuboidal shaped enclosures having one face open to receive the electrical devices. The electrical outlet box having one or more access post(s) provided in the side walls or rear walls of the electrical outlet box for the conduits to gain access to the interior of the electrical outlet box. The electrical outlet boxes can be mounted to the exterior of walls, studs, and like supporting structures of a building. The standard procedure is to pull in the conduits through the access ports into the electrical outlet box. The electrical outlet box can be mounted using nails or screws to the supporting structure. The electrical connections can then be made to the electrical devices, and thereafter, the electrical devices can be mounted to the electrical outlet box. A cover plate can also be applied to the electrical outlet box thereafter.

The electrical outlet boxes are available in different widths to accommodate one or more electrical devices. Based on the width of the electrical outlet boxes, these can be called single gang, 2-gang, 3-gang, 4-gang, and so on electrical outlet boxes. Standard rectangular boxes are one gang electrical outlet boxes that can receive a single switch or receptacle outlet. The standard rectangular boxes are also available in gangable forms, i.e. with detachable sides that can be removed so the boxes can be linked together to form larger boxes for holding two, three, or more devices side-by-side.

Electrical devices that are most commonly used in the electrical wiring of a building includes switches and receptacle outlets. The switches are generally rocker switches. The receptacle outlets are available with one (simplex), two (duplex), or three (triplex) receptacles into which the blades of the appliance plug can fit.

The electrical outlet box and electrical devices are available in a range of designs and shapes, however, installing the electrical outlet boxes and the electrical devices can be a tedious and time-consuming task. Moreover, to install or replace a damaged electrical device, a technician has to cutoff the supply of electricity from the main circuit panel of the building or floor. This is both uncomfortable and time-consuming. Thus, there is a long-term need for improved electrical housing assembly that is quick to install to a supporting structure and also allows safe and quick installation and replacement of the electrical devices.

The phrase “electrical device” hereinafter refers to switches, outlet receptacles, and like which provides access to the electrical power in the wiring of a building. The Receptacle outlets can be one (simplex), two (duplex), or three (triplex) receptacles.

### SUMMARY OF THE INVENTION

The principal object of the present invention is therefore directed to an improved electrical outlet box assembly that is easy to install.

It is an additional object of the present invention that the electrical outlet box assembly allows installing and replacing the electrical devices safely.

It is another object of the present invention that electrical outlet box allows quick installing and replacing of the electrical devices.

It is yet another object of the present invention that electrical outlet box assembly is economical to manufacture.

The above and other objects of the invention are realized in a specific illustrative embodiment thereof which includes a modular outlet box. The modular outlet box can be a box-like structure having continuous sidewalls and a rear wall, the sidewalls upstanding from the rear wall. The front face of the electrical outlet box is open. The rear side of the electrical outlet box can be provided with a first contacts module for connecting to the conduit from a power supply. The first contacts module in electrical communication with a second contacts module through a conductor link. The conductor link is interrupted by a circuit breaker installed in the modular outlet box. The circuit breaker can switch between a first position and a second position, in the first position, the electrical current can flow between the first contacts module and the second contacts module. In the second position, the flow of current in the conductor link is interrupted. The switching of the circuit breaker between the first position and the second position can be controlled by a key, the key is accessible from outside of the electrical outlet box.

In one aspect, the electrical outlet box assembly further comprises a mounting bracket that can be mounted to a stud. The modular outlet box and the mounting bracket can have interconnecting mating structures for removably coupling the modular outlet box to the mounting bracket.

These and other objects and advantages of the embodiments herein will become readily apparent from the following detailed description.

### BRIEF DESCRIPTION OF THE DRAWINGS

FIG. 1A is a perspective view of a mounting plate, according to an embodiment of the present invention.

FIG. 1B is an exploded view of the mounting plate of FIG. 1A, according to an embodiment of the present invention.

FIG. 2 is a perspective view of a modular outlet box, according to the present invention.

FIG. 3 is a front view of the modular outlet box of FIG. 2, according to the present invention.

FIG. 4 is an exploded view of the modular outlet box of FIG. 2, according to an embodiment of the present invention.

FIG. 5A is a perspective view of another embodiment of the modular outlet box showing a back cover in an open position, according to an embodiment of the present invention.

FIG. 5B is a perspective view of the modular outlet box of FIG. 5A having the back cover in a closed position, according to an embodiment of the present invention.

FIG. 5C is an exploded view of the modular outlet box of FIG. 5A, according to an embodiment of the present invention.

FIG. 5D shows the terminal, according to an embodiment of the present invention.

FIG. 5E shows the drywall grip, according to an embodiment of the present invention.

FIG. 6A is a perspective view of a rocker switch, according to an embodiment of the present invention.

FIG. 6B is an exploded view of the rocker switch of FIG. 6A, according to an embodiment of the present invention.

FIG. 7A is a perspective view of an outlet receptacle, according to an embodiment of the present invention.

FIG. 7B is a rear view of the outlet receptacle of FIG. 7A, according to an embodiment of the present invention.

FIG. 7C is an exploded view of the outlet receptacle of FIG. 7A, according to an embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as compositions or methods of treatment. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

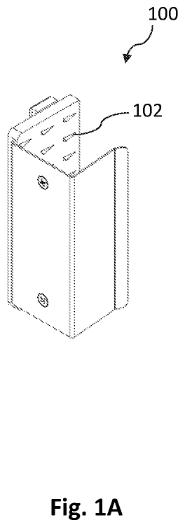

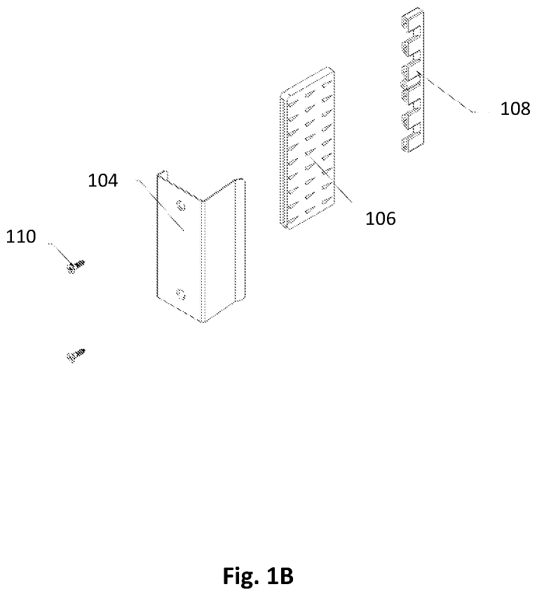

The present invention is directed to an electrical outlet box assembly that is easy to install to stud and can quickly and safely house the electrical devices. The electrical outlet box assembly includes a mounting plate and a modular outlet box, the modular outlet box can be mounted to the mounting plate and houses the electrical devices including switches and outlet receptacles. The mounting plate can be coupled to a stud. Now referring to FIG. 1A, which shows an exemplary embodiment of the mounting plate 100. The mounting plate 100 is adapted to mount to a stud. The mounting plate 100 is shown to have teeth like projections 102 on the inner surface of a side wall of the mounting plate 100. The projections can be shaped to grab onto the metal stud and hold the mounting plate 100 in place. Now referring to FIG. 1B, which is an exploded view of the mounting plate of FIG. 1A showing a bracket 104, mounting member 106, a drywall spacer 108, and a pair of wood screws 110.

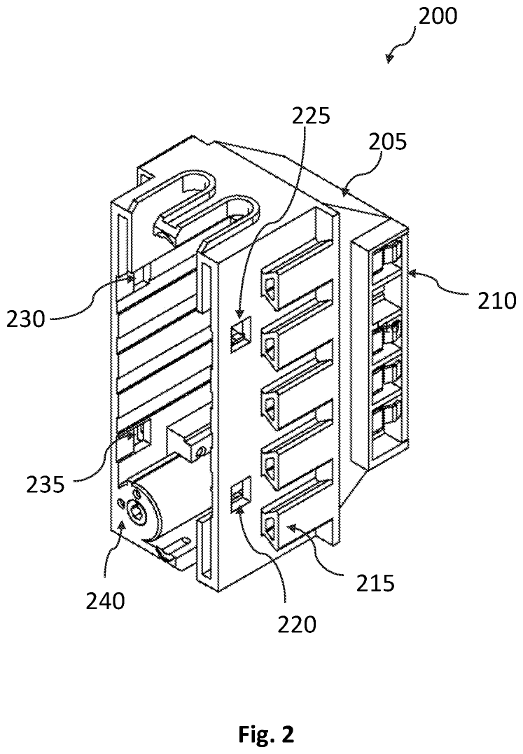

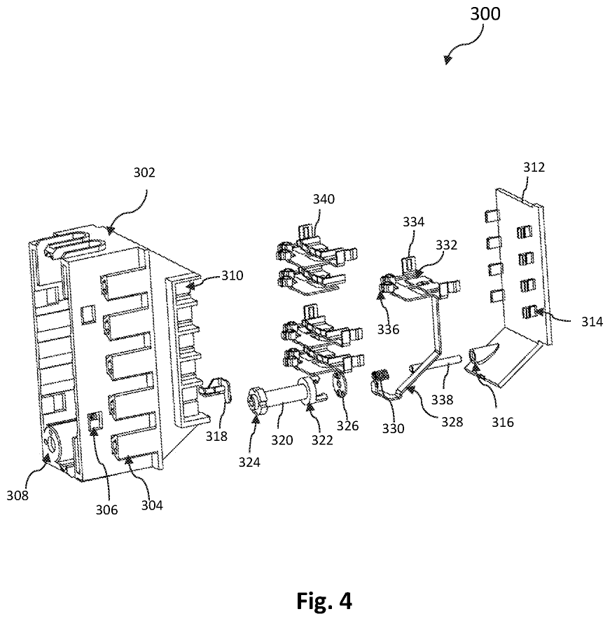

FIG. 2 shows an exemplary embodiment of the modular outlet box 200 that is of the cuboidal box-like shape, having a rear wall 205 and side walls upstanding from the rear wall. The front face along the perimeter of the side walls is open to receive the electrical devices. The side face of the rear wall 205 is having a first contacts module 210 which includes electrical terminals for connecting to the electrical conduits from the main power source. The sidewalls of the modular outlet box 200 having spaced apart mounting slides 215 for slidably engaging the modular outlet box 200 to the mounting plate 100. The Mounting slides 215 can also be used to gang the modular outlet box 200 with another modular outlet box. Furthermore, it can be seen on the sidewalls are four locking grooves 220, 225, 230, and 235 for securing the electrical devices to the modular outlet box 200. Access 240 provides access to a key explained below with reference to FIG. 4.

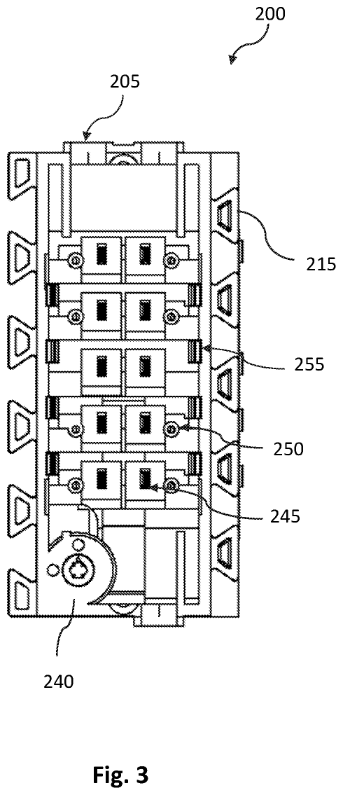

FIG. 3 is the front view of the modular outlet box 200 further showing the second contacts module 245. The second contacts modules 245 having electrical contact terminals for electrically connecting to the electrical devices. The first contacts module 210 can be electrically coupled to the second contacts module 245 through a conductor link. The conductor link can be interrupted by a circuit breaker also housed in the modular electrical outlet box 200. The circuit breaker is configured to switch between a first position and a second position. In the first position, the electrical current can flow between the first contacts module 210 and the second contacts module 245 through the conductor link. In a second position, the electrical current is interrupted and does not flow from the first contacts module 210 to the second contacts module 245 through the conductor link. The circuit breaker can be switched between the first position and the second position through a key. The key can be accessed from outside of the modular outlet box for switching the circuit breaker between the first position and the second position. Access 240 is in the form of a screw boss that opens on the front side of the modular outlet box 200 and allows access to the key. The locking arms 255 can secure the electrical device to the modular outlet box 200.

FIG. 4 shows an exploded view of the modular outlet box 300. The modular outlet box 300 having sidewalls 302, the sidewalls 302 having mounting slides 304, locking grove 306, access 308, a back cover plate 312, locking arm 314, alignment grove 316, an internal contact 318, key 320 of the circuit breaker, head of the key 324, a connector of the key 322, a second connector of the key 326. The breaker circuit and the conductor link are represented by elements 328, 330, 332, 334, and 336. Alignment rod 338 connects with the alignment groove 310 for aligning the back-cover plate 312. Internal contacts 340 are parts of circuit breaker and the conductor link. The mounting slides 304 are a part of a mating structure that can couple the modular outlet box to the mounting plate.

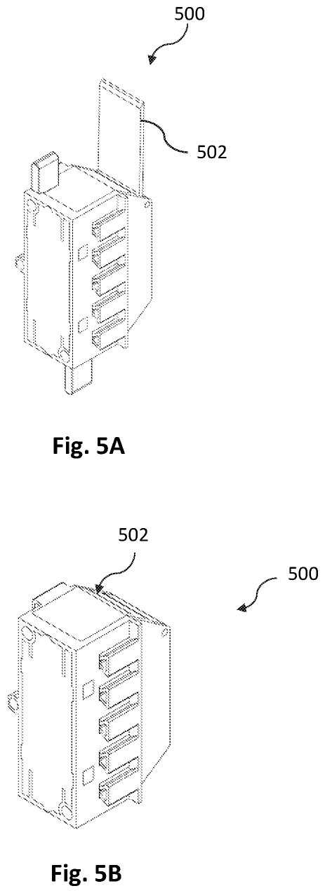

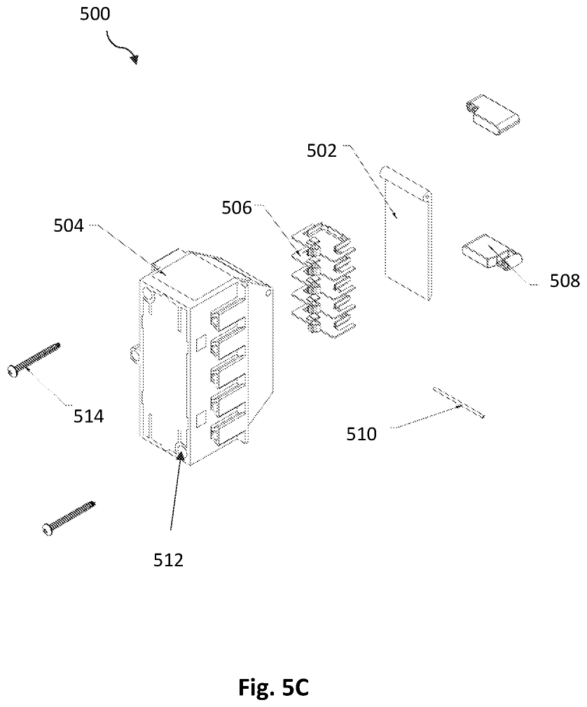

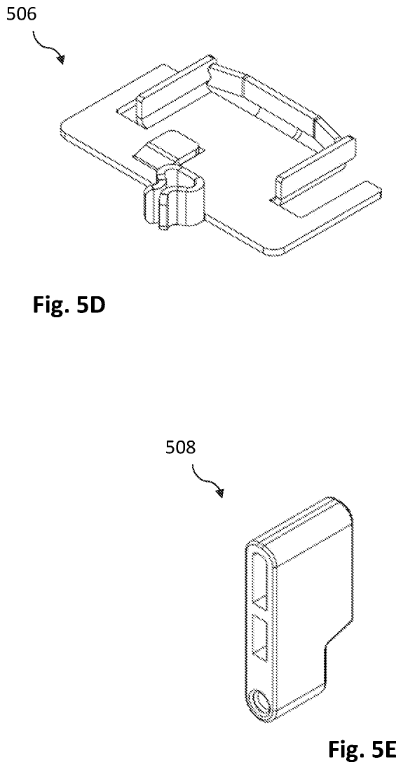

FIG. 5A shows another exemplary embodiment of the modular outlet box 500 having a back cover 502. FIG. 5A shows the back cover in an open state, while FIG. 5B shows the back cover in a closed state. The back cover 502 can slide fit into the modular outlet box 500. FIG. 5C is an exploded view of the modular outlet box 500 showing the housing 504 of the modular outlet box 500, five terminals 506, back cover 502, Drywall grip 508, Dowel pin 510, and screws 514. The modular outlet box 500 can primarily include six parts. The housing 504 of the modular outlet box 500 can house the internal components of the modular outlet box 500. Second, the terminals 506, which once connected to the main power source can power up to provide power for the electrical device(s) that couple with the modular outlet box 500. Third, the back cover 502 can cover the main power wires coming from the panel into the modular outlet box 500. Fourth are the drywall grip 508 that can secure the modular outlet box 500 to drywall for the stability of the modular outlet box 500. When screwed in, the drywall grips 508 can tighten themselves to the back of the drywall so the box is secured into place and does not move when outside pressure is applied to the drywall grips 508. Fifth, the dowel pin 510 can secure the back cover 502 in place and allows the back cover 502 to open and close.

Sixth, the modular outlet box 500 includes the circuit breaker (not shown in FIG. 5C) as explained above with reference to the FIG. 4. The circuit breaker can be connected to the terminals 506 to break the power from the main power supply. The circuit breaker can allow a technician to work on the inside of the modular outlet box 500 without having to go back to the main panel to cut off the power supply. The back cover 502 is having a flat body and a folded lip on the top edge. Moreover, it can be seen that the first contacts module 210 of modular outlet box 200 is absent in the modular outlet box 500 shown in FIG. 5A. The first contacts module 210 can power up the ganged modular outlet boxes without having to individually wire in (once the first modular outlet box is wired in, all the modular outlet boxes connecting to the first could automatically power up through the connecting contacts, eliminating having to wire in all boxes). The contact module 210 can however be optional. FIG. 5D shows a perspective view of the terminal 506. FIG. 5E shows a perspective view of the drywall grip 508.

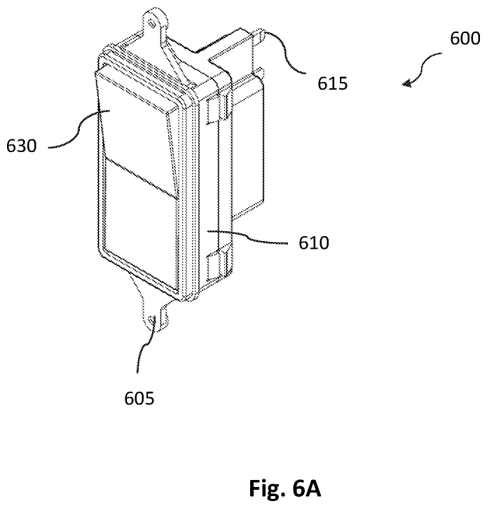

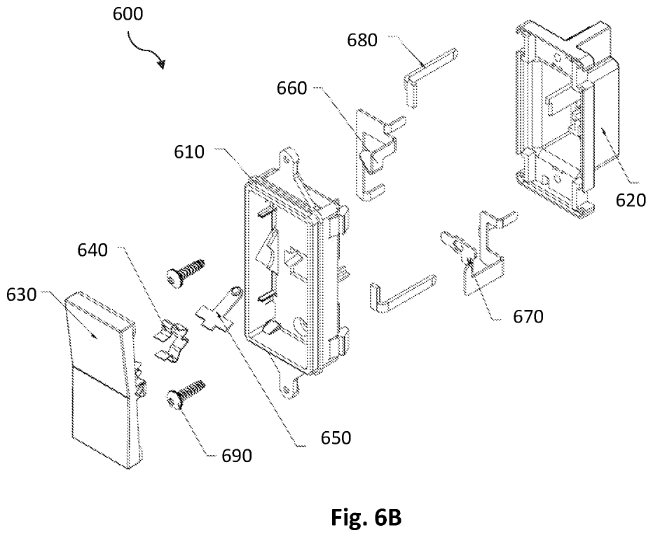

FIG. 6A shows an exemplary embodiment of the electrical device which is a rocker switch 600 that can be coupled with the modular outlet box. FIG. 6A is a perspective view of the rocker switch showing the front member 630, extensions 605, switch housing 610, and electrical terminals 615. The terminals 615 can electrically connect to the second contacts module of the modular outlet box. The extensions 605 can allow securing the rocker switch 600 to the screw bosses 512 of the modular outlet box 500. FIG. 6B is an exploded view of the rocker switch 600 showing the switch housing top 610, switch housing bottom 620, rocker 630, rocker spring 640, switch actuator 650, contact rocker traveler 660, contact rocker hot wire 670, a pair of contact rocker ground 680, and a pair of screws 690. A cover plate can be secured to the modular outer box over the rocker switch. The cover plates for electrical fixtures are known in the art.

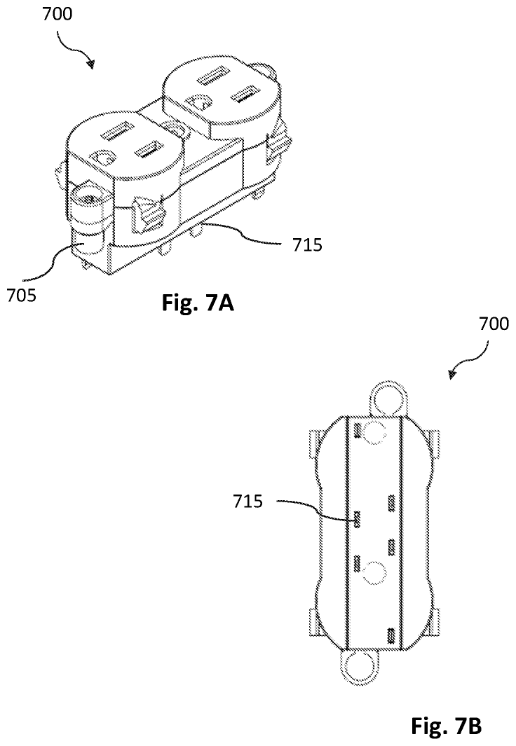

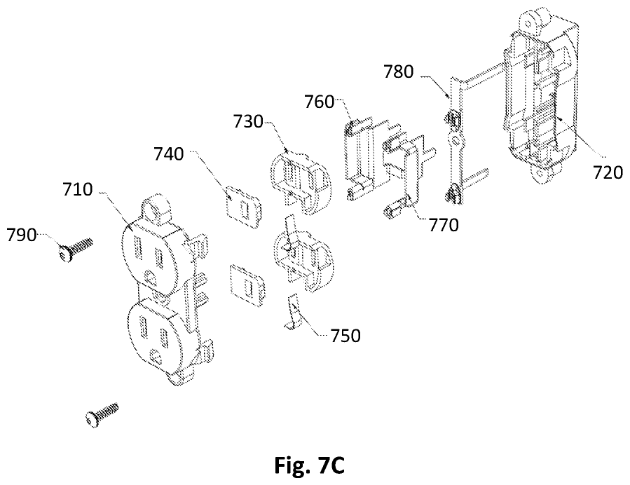

FIGS. 7A and 7B show an exemplary embodiment of the electrical device which is an outlet receptacle 700 that can be coupled with the modular outlet box. FIG. 7A is a perspective view of the outlet receptacle 700, while FIG. 7B is rearview. FIG. 7A shows the extensions 705 that provides for coupling the outlet receptacle 700 to screw bosses 512 of the modular outlet box 500. Electrical terminals 615 can electrically connect to the second contacts module of the modular outlet box 500. FIG. 7C is the exploded view of the outlet receptacle 700 showing the outlet housing top 710, outlet housing bottom 720, a pair of outlet cover 730, a pair of outlet cover plate 640, a pair of outlet cover spring 650, contact outlet neutral 660, contact outlet hot wire 670, contact outlet GND 680, and a pair of screws 690.

In one exemplary embodiment of the present invention, the modular outlet box can further include a control unit that can be activated by voice command or remote control. Voice-activated electrical switches and remote-controlled electrical switches are known in the art. The present invention encompasses all known methods for remotely activating the electrical devices coupled to the modular outlet box of the present invention. In one case, the control unit can function independently of the electrical device. In one case, the control unit can be equipped with “smart technology” i.e. Self-Monitoring Analysis and Reporting Technology, which is known in the art.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An electrical outlet box assembly comprising:
a modular outlet box having a rear wall, side walls upstanding from the rear wall, and an open front face;
a first contacts module configured in the modular outlet box, the first contacts module adapted to electrically connect to power conduits;
a second contacts module configured into the modular outlet box, the second contacts module configured to electrically connect with an electrical device;
a conductor link electrically connecting the first contacts module and the second contacts module;
a circuit breaker electrically interrupting the conductor link, the circuit breaker configured to switch between a first position and a second position, wherein in the first position current flows through the conductor link from the first contacts module to the second contacts module, and in the second position the current does not flow from the first contacts module to the second contacts module; and
a key coupled to the circuit breaker for switching the circuit breaker between the first position and the second position.

2. The electrical outlet box assembly of claim 1, wherein the electrical device is a rocker switch.

3. The electrical outlet box assembly of claim 1, wherein the electrical device is an outlet receptacle.

4. The electrical outlet box assembly of claim 1, wherein the modular outlet box further comprises a screw boss extending within the modular outlet box towards the open front face, the screw boss configured for gaining access from outside of the modular outlet box for turning the key.

5. The electrical outlet box assembly of claim 1, wherein the electrical outlet box assembly further comprises:
a mounting plate configured to couple to a stud, the mounting plate and the modular outlet box having a mating structure configured to allow the mounting plate to removably couple with the modular outlet box.

6. The electrical outlet box assembly of claim 5, wherein an inner surface of at least one side of the mounting plate is having teeth shaped projections.

7. The electrical outlet box assembly of claim 5, wherein the mating structure comprises a male member and a female member, wherein the male member configured to removably and snugly receive within the female member.

8. The electrical outlet box assembly of claim 7, wherein the male member is configured on at least one of the side walls of the modular outlet box, and the female member is configured on a side of the mounting plate.

9. The electrical outlet box assembly of claim 5, wherein the mating structure is further configured to allow the modular outlet box to gang with another modular outlet box.

10. The electrical outlet box assembly of claim 9, wherein the first contacts module is configured to power the another modular outlet box.

11. The electrical outlet box assembly of claim 1, wherein the electrical outlet box assembly further comprises a drywall grip configured for securing the modular outlet box to a drywall.
